(19) United States
(12) Patent Application Publication
(10) Pub. No.: US 2017/0020107 A1
(43) Pub. Date: Jan. 26, 2017

(54) Groomer and Veterinarian Pet Harness System and Method of Using Same

(71) Applicant: WOSS Enterprises LLC, Antioch, CA (US)

(72) Inventors: Steven Storum, San Carlos, CA (US); Wolfgang Ott, Antioch, CA (US)

(73) Assignee: WOSS ENTERPRISES LLC, Antioch, CA (US)

(21) Appl. No.: 14/805,012

(22) Filed: Jul. 21, 2015

(51) Int. Cl. A01K 1/06; A44B 11/06; A61D 3/00; A44B 11/00; A01K 27/00; A01K 13/00

(52) U.S. Cl. CPC A01K 1/0613; A01K 27/003; A01K 27/001; A01K 13/00; A61D 3/00; A44B 11/005; A44B 11/06; A61D 2003/003

(57) ABSTRACT

An animal harness for use together with a stand by veterinarians and groomers and the like in which elongated members form an adjustable size loop that encircles the animal's head and extends to cam buckles supported by the stand.

### BACKGROUND

The present invention relates to pet harness systems and components therefore and, more particularly, to such pet harness systems used, for example, by groomers and veterinarians to restrain pets (such as dogs and cats) while receiving services.

When a groomer or veterinarian services a pet, it is often necessary to restrain the animal using a harness typically attached to a vertical rigid stand. It is important to effectively restrain the animal so that services can be carried out, but in such a way as to not harm the animal by choking or the like. It is also important to be able to quickly release the animal from the harness in the event that the animal gets agitated and could be injured if retained in the harness.

### BRIEF DESCRIPTION OF THE INVENTION

In one embodiment, a pet harness for use with a stand having a vertical member and a horizontal member comprises an upper cam buckle securable to the horizontal member and a lower cam buckle securable to the vertical member.

One or more elongated members secured together at a first end and at a spaced-apart second end form a closed loop between the first end and the second end and a slide lock is disposed about the loop between the first end and the second end whereby the slide lock can be positioned at a selected location between the first end and the second end where the slide lock resists movement away from the selected location.

A first extension elongated member is secured at the first end and is of a length sufficient to extend from the first end to and beyond the upper cam buckle, and a second extension elongated member secured at the second end and of a length sufficient to extend from the second end to and beyond the second cam buckle.

The harness is used by first locating the slide lock near or at the first end and then gently placing the closed loop around the pet's head and securing the first extension elongated member through the upper cam buckle and the second extension elongated member through the lower cam buckle. The slide lock is then moved to reduce the size of the loop around the animal's neck until it is located at the back of the animal's neck and the first extension strap is pulled through the cam buckle to take up the slack. The second extension elongated member is then pulled through the lower cam buckle until the slack is taken up, making sure there is ample space between the second end of the loop and the animal's neck so as not to create a choking hazard. By being able to secure the lower cam buckle at any selected location on the vertical member of the stand, the harness can be tailored to animals of different sizes and still maintain the spacing that effectively restrains the animal without creating a choking hazard.

In the event that an animal becomes agitated and could be harmed if not quickly released from the harness, the operator simply depresses the cam buckle lever to fully release the animal. It is important to be able to quickly release the upper restraint in the event the animal falls over the edge of the table and hangs there.

The first and second extension elongated members working together with the cam buckles as described above eliminate the need for a plurality of straps of different lengths to accommodate animals of different sizes as is the need in prior art harnesses.

The novel arrangement of elongated members and connection hardware that comprise the harness systems of the present invention provide superior performance and flexibility as compared to prior art systems while providing for the safety of the animals.

The elongated members can be of a variety of materials including, without limitation, rope, webbing, cord and the like. In one embodiment, the elongated member(s) that forms the closed loop that circumscribes the animal's neck are of a rope material having a generally circular cross-section while the extension straps are of flat webbing which works very well with cam buckles. However, those skilled in the art will recognize that various other materials could be used without departing from the invention.

### DESCRIPTION OF THE DRAWINGS

FIG. 1 is a side view of a standard grooming stand to which an embodiment of the harness of the present invention is attached;

FIG. 2 is similar to FIG. 1 with the addition of an animal (dog) in the harness; and

FIG. 3 is a plan view of a universal cam buckle bracket including a cam buckle.

### DETAILED DESCRIPTION

The following terms used herein shall be understood to have the following meanings:

“Slide lock”: a device that can be disposed at a selected location along an elongated member and where it will resist movement until manually moved to a different location along the elongated member.

“Cam buckle”: a device that releasably secures an elongated member at a selected location along the length of the elongated member.

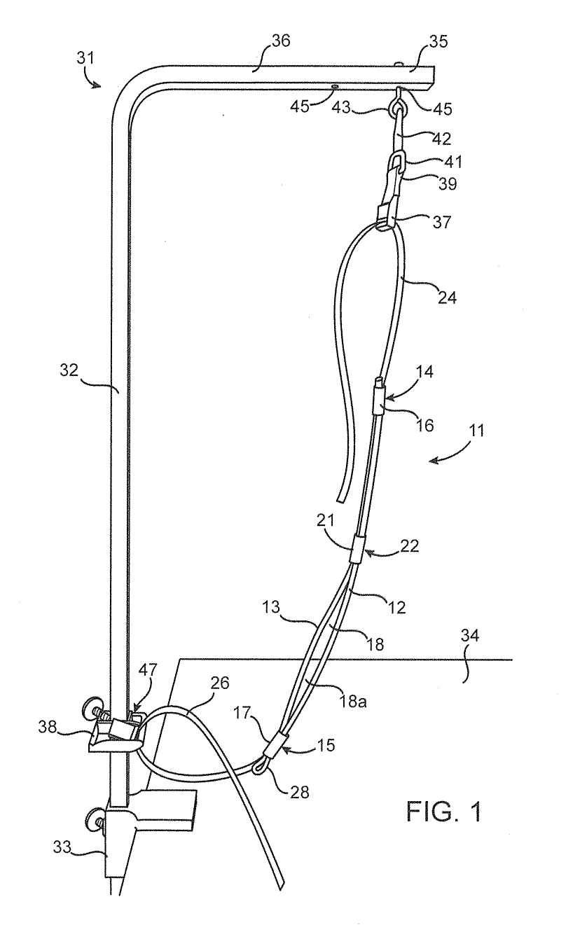

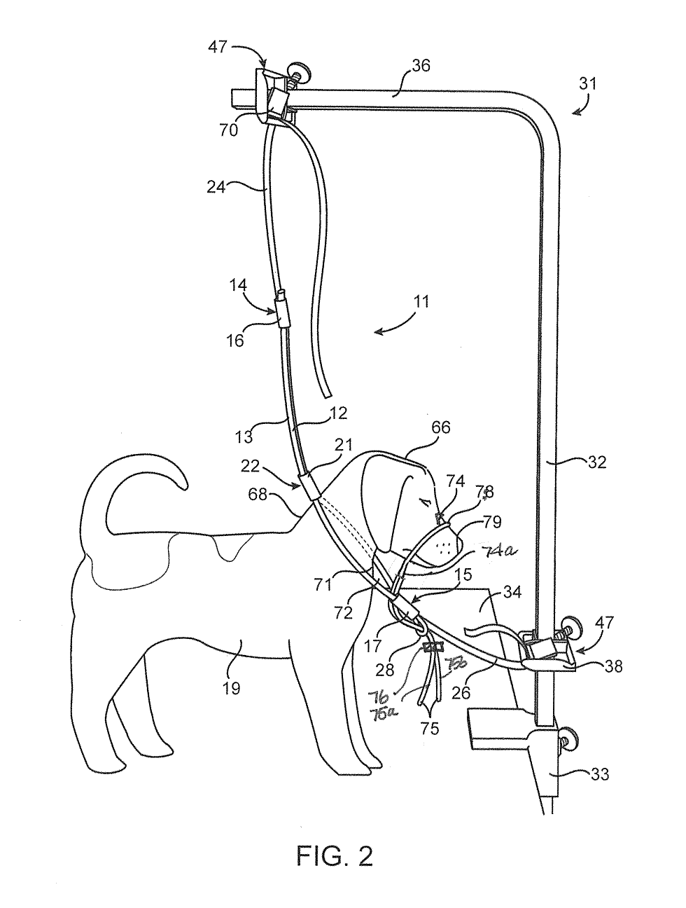

Referring to FIGS. 1 and 2, a pet restraint harness system 11 includes a closed loop 18 formed by side-by-side elongated members 12 and 13 that are secured together at a first end 14 and a spaced-apart second end 15. Elongated members 12 and 13 can be portions of a single elongated member folded over onto itself, or two separate elongated members. In one embodiment, elongated members 12 and 13 are secured together at the first end 14 by inserting them into a deformable metal crimp sleeve 16 and then crimping the sleeve to reduce its diameter (in a manner well known in the art) until the two elongated members 12 and 13 are secured together. The elongated members 12 and 13 are similarly secured together at the second end 15 by a second crimped sleeve 17. With the first and second ends 14 and 15 so secured together, elongated members 12 and 13 form the closed loop 18 that is large enough to comfortably fit over the head of an animal (such as a dog) 19 of various sizes.

It will be appreciated by those skilled in the art that the joinder of the elongated members 12 and 13 can be effected by devices other than crimped sleeves 16 and 17, such as by stitching or any one of numerous known devices for joining two elongated members together, such that the invention is not limited to embodiments of crimped sleeves.

A slide lock 22 is formed from a third crimp sleeve 21. After the ends of elongated members 12 and 13 are disposed in crimp sleeve 21, the diameter of crimp sleeve 21 is reduced enough to fully engage the elongated members 12 and 13 but without fixedly securing them together. Rather, the degree of engagement of the crimp sleeve 21 after it is crimped permits it to slide along the length of the first and second elongated members 12 and 13 to any selected location between first end 14 and second end 15 where it will resist movement until manually relocated. By positioning the slide lock 22 along the elongated members 12 and 13, a loop 18a is formed between the slide lock 22 and the second end 15 which will vary in size depending on the location of the slide lock 22. In this way, animals of different sizes can be accommodated without additional elongated members.

While crimp sleeve 21 is an advantageous embodiment of the slide lock 22, it will be appreciated by those skilled in the art that a variety of devices exist and are known that are capable of performing the function of being secured at a selected position between the first and second ends 14 and 15 and manually movable to a different selected position as described for crimp sleeve slide lock 22 such that the invention is not limited to an embodiment of a crimped sleeve slide lock.

In one embodiment, elongated members 12 and 13 are a rope material having a generally circular cross-section which works well with crimp sleeves, both in securing the ends and forming a simple but effective slide lock. Other embodiments using different materials for the elongated members 12 and 13, such as webbing, are possible and within the scope of the invention.

A first extension elongated member 24 is secured by and extends from the first crimp sleeve 16 (first end 14), while a second extension elongated member 26 is secured by and extends from the second crimp sleeve 17 (second end 15). As more fully described below, the first extension elongated member 24 passes through and is secured by an upper cam buckle 37 (FIG. 1), while the second extension elongated member 26 passes through and is secured by a lower cam buckle 38.

Extending from sleeve 17 is a muzzle connection loop 28. In one embodiment, loop 28 is formed from a portion of elongated member 12 and/or 13. Alternatively, muzzle connection loop 28 is formed from an elongated member separate from elongated member 12 or 13 or is an affixed metal or plastic ring (not shown) secured at sleeve 17.

A commercially available grooming stand 31 is typical and has a vertical member 32 affixed to a clamp fixture 33 that secures the stand 31 to a grooming or examining table 34. A horizontal member 36 of grooming stand 31 extends from vertical member 32 above and over table 34.

Upper cam buckle 37 is secured to and near the end 35 of horizontal member 36 and disposed to receive the first extension elongated member 24. It is common that commercially available grooming stands 31 have one or two apertures 45 in the horizontal member 36 and for an eye bolt 43 to be secured in an aperture 45. Unlike the prior art where the harness system's primary connection to the grooming stand 31 is by a snap hook 42, or the like, directly onto eye bolt 43, in the invention embodiment illustrated, the eye bolt 43 supports upper cam buckle 37 (as described below) which is a primary connection point of the loop 18.

In the embodiment illustrated, cam buckle 37 is secured to horizontal member 36 by a connection strap 39 which connects to a D-ring 41, which, in turn, is secured to snap hook 42 which connects to the eye bolt 43 which is secured in horizontal member 36 at an aperture 45. The invention is not limited to the particular connection arrangement described above for securing cam buckle 37 to eye bolt 43. In one embodiment described below, a novel universal cam buckle bracket secures the cam buckle to either or both of the vertical member 32 and horizontal member 36.

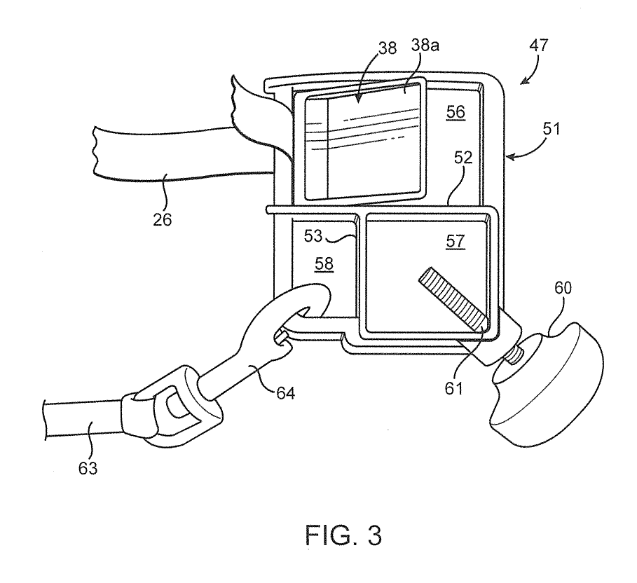

Referring to FIGS. 1, 2 and 3, a universal cam buckle bracket 47 is attached to vertical member 32 and disposed at any selected location along the length of vertical member 32. The universal cam buckle bracket 47 comprises a rigid frame 51 enclosing a space, and dividers 52 and 53 that partition the space within frame 51 into separate spaces 56, 57 and 58. In one embodiment, separate spaces 56, 57 and 58 are essentially enclosed, as shown.

Space 56 forms a part of and contains cam buckle 38 including its spring-loaded armature 38a. As is well known in the art, armature 38a is spring-loaded to apply pressure to elongated member 26 and secure it within cam buckle 38 until the armature 38a is depressed, releasing the pressure on the elongated member 26. Space 57 is sized to be larger than the cross-section of vertical member 32 such that vertical member 32 fits inside the essentially enclosed space 57. A clamping screw 60 is threaded through the corner 61 of frame 51 and into space 57. With the vertical member 32 disposed within space 57 (FIG. 1), the universal cam buckle bracket 47 is positioned at a desired location on the vertical member 32 and the clamping screw 60 tightened until clamp 47 is secured in place. Universal cam buckle bracket 47 works equally well with members 32 having circular or other cross-sections (not shown). As shown in FIG. 2 universal cam buckle bracket 47 works equally well on horizontal member 36.

Space 58 provides a convenient location for attaching an auxiliary strap 63, such as a leash, with a snap hook 64 or the like.

Referring to FIG. 2, an advantage of the universal cam buckle bracket 47 is that it can replace the cam buckle 37 and eye bolt assembly (39, 41 and 42) (FIG. 1), allowing the cam buckle to be located anywhere along horizontal member 36 and not just where there are pre-drilled apertures 45 for an eye hook.

While universal cam buckle bracket 47 has certain advantages, it will occur to those skilled in the art that other clamp mechanisms can be joined to a cam buckle whereby the cam buckle can be secured at any selected location on a supporting member such that the invention is not limited to the particular integrated clamp-cam buckle combination described herein.

Referring to FIGS. 1 and 2, the method of use of pet restraint harness system 11 of the invention described above and in the FIGS. comprises the steps of: securing the first extension elongated member 24 through an upper cam buckle 70; securing the second extension elongated member 26 through a lower cam buckle 38; locating slide lock 22 near or at the first end 14; gently placing the loop 18 over the head 66 of pet 19; positioning slide lock 22 at the back of the neck 68 of pet 19; pulling first extension elongated member 24 through upper cam buckle 70 to take up the slack in first extension elongated member 24; pulling the second extension elongated member 26 through the cam buckle 38 to take up the slack; positioning universal cam buckle bracket 47 on vertical member 32 to where second end 15 is positioned away from the throat 71 of pet 19, creating a safety space 72 that eliminates a potential choking hazard.

The method of the invention is not limited by the particular order of steps described above, as a different order is within the scope of the invention.

Referring to FIG. 2, a novel muzzle 74 comprises a doubled length of an elongated member 75 (such as rope or webbing or the like) and a slide lock 76 that surrounds both arms 75a and 75b of the doubled length of elongated member 75. A muzzle loop 74a is formed between the slide lock 76 and the end 78 of the doubled length of elongated material 75. The muzzle loop 74a is sizable by positioning slide lock 76. To implement the muzzle 74, the end 78 is passed through muzzle connection loop 28 (see FIG. 1) and between the second end 15 (crimped sleeve 17) and the animal's throat 71 and then looped around the dog's snout 79. Once so positioned, the elongated member is pulled through the slide lock 76 (slide lock 76 is pushed along elongated member 75) until the muzzle loop 74a is firmly around the dog's snout 79 as shown.

Of course, various changes, modifications and alterations in the teachings of the present invention may be contemplated by those skilled in the art without departing from the intended spirit and scope thereof. As such, it is intended that the present invention only be limited by the terms of the appended claims.

1. A pet harness for use with a stand having a vertical member and a horizontal member comprising:
an upper cam buckle securable to said horizontal member;
a lower cam buckle securable to said vertical member;
a closed loop having a first end and a second end;
a slide lock operatively connected to said closed loop between said first and second ends of said loop whereby said slide lock is selectively positionable at any location between said first loop end and said second loop end;
a first extension elongated member extending from said first end and having a length that reaches to and beyond said upper cam buckle; and
a second extension elongated member extending from said second end and having a length that reaches to and beyond said lower cam buckle.

2. The pet harness of claim 1 further comprising a muzzle loop extending from said second end.

3. The pet harness of claim 1 further comprising a universal cam buckle bracket affixable to the vertical member and wherein said lower cam buckle is integral with said universal cam buckle bracket.

4. The pet harness of claim 1 further comprising a universal cam buckle bracket affixable to the horizontal member and wherein said upper cam buckle is integral with said universal cam buckle bracket.

5. The pet harness of claim 4 further comprising a universal cam buckle bracket affixable to the horizontal member and wherein said upper cam buckle is integral with said universal cam buckle bracket.

6. The pet harness of claim 3 wherein said cam buckle bracket comprises:
a cam buckle; and
a securing bracket attached to said cam buckle including a clamp for securing said bracket and cam buckle at selected locations on said horizontal or vertical member.

7. The pet harness of claim 3 wherein said cam buckle bracket comprises:
a rigid frame defining an interior space:
dividers within said frame that, together with said frame, partition said interior space into multiple separated spaces;
a cam buckle disposed in one of said separate spaces; and
a securing clamp disposed in another of said separate spaces.

8. The pet harness of claim 7 wherein said securing clamp comprises:
a said separate space sized to receive an member of the stand; and
a screw disposed through said frame and into said separate space sized to receive an member of the stand and positioned to bear against an member of the stand whereby said frame is secured at a selected location on said stand member.

9. The pet harness of claim 6 further comprising:
an additional said frame separate space to which a securing mechanism can be attached.

10. A pet harness for use with a stand having a vertical member and a horizontal member comprising:
a first cam buckle secured to a said member of the stand;
a loop; and
a first elongated member disposed between said loop to said cam buckle.

11. The pet harness of claim 10 further comprising:
a slide lock operatively connect to said loop.

12. The pet harness of claim 10 wherein said first cam buckle is secured to the vertical member of the stand and further comprising:
a second cam buckle secured to the horizontal member of the stand; and
a second elongated member disposed between said loop to said second cam buckle.

13. A cam buckle bracket comprising:
a rigid frame:
dividers within said frame that, together with said frame, partition said interior space into multiple separate spaces;
a cam buckle disposed in one of said separate spaces; and
a securing clamp disposed in another of said separate spaces.

14. The cam buckle bracket of claim 13 wherein said securing clamp comprises:
a said separate space sized to receive an member of the stand; and
a screw disposed through said frame and into said separate space sized to receive an member of the stand so as to bear against an member of the stand within said separate space sized to receive an member of the stand whereby said frame is secured at a selected location on the stand member.

15. The pet harness of claim 13 further comprising:
an additional said enclosed space to which a securing mechanism can be attached.
